(19) United States
(12) Patent Application Publication
(10) Pub. No.: US 2010/0075105 A1
(43) Pub. Date: Mar. 25, 2010

(54) FILM AND HOUSING USING THE FILM

(75) Inventors: CHENG-WEN SU, Shindian (TW); GANG HUANG, Shenzhen City (CN); ZHONG-DAN DENG, Shenzhen City (CN); YIN-JIE GUO, Shenzhen City (CN); TZU-CHENG YU, SantaClara, CA (US); SHENG-FENG HUNG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/547,696

(22) Filed: Aug. 26, 2009

(30) Foreign Application Priority Data
Sep. 19, 2008 (CN) 200810304585.0

(51) Int. Cl. B32B 7/00; B32B 3/00

(52) U.S. Cl. 428/119; 428/189

(57) ABSTRACT

A film comprises a base layer, a first patterned layer and a second patterned layer. The base layer includes a first surface and a second surface opposite to the first surface. The first patterned layer is laminated with the base layer partially over the first surface of the base layer. The first patterned layer is belt-shaped and includes a plurality of spaced first strip patterns, such that a first interval space is defined between adjacent two first strip pattern. The second patterned layer is laminated with the base layer partially over the second surface of the base layer. The second patterned layer being belt-shaped and includes a plurality of spaced second strip patterns corresponding to the first strip patterns. The second strip patterns are partially overlapped with corresponding first strip patterns and the rest of the second strip patterns are partially overlapped with corresponding first interval spaces.

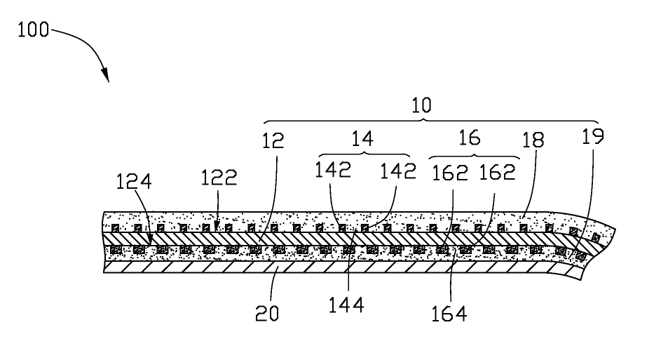

This application is related to co-pending U.S. Patent Applications (Attorney Docket No. US24234), entitled “HOUSING”, by Wei Li et al. Such application has the same assignee as the present application and has been concurrently filed herewith. The above-identified applications are incorporated herein by reference.

### BACKGROUND

1. Technical Field

The exemplary disclosure generally relates to films, and particularly to films used in In-Mold Labeling (IML), and housings using the films.

2. Description of Related Art

Portable electronic devices (such as mobile telephones and electronic notebooks) are in widespread use. The external appearance of the housing of the portable electronic device has become a key factor for attracting consumers.

The external appearance of the housing can usually be made by In-Mold Labeling (IML). A film with predetermined patterns, text, or pictures is placed in the die and directly molded to a housing molded within the die. However, the appearance of the housing made by said method is not dynamic, so that can not meet the requirement of dynamic appearance of the housing.

Thus, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the exemplary film and housing using the film. Moreover, in the drawings like reference numerals designate corresponding parts throughout the several views. Wherever possible, the same reference numbers are used throughout the drawings to refer to the same or like elements of an embodiment.

The FIGURE is a partially cross-section view of an exemplary embodiment of a film used in a housing, the housing including a substrate and the film formed on the substrate.

### DETAILED DESCRIPTION

The FIGURE depicts an exemplary embodiment of a film 10 that can be used in a housing 100 including a substrate 20 and the film 10 formed on the substrate 20. The film 10 includes a transparent base layer 12, a first patterned layer 14 and a second patterned layer 16. The first patterned layer 14 is laminated with the base layer 12 partially over a first surface 122 of the base layer 12. The second patterned layer 16 is laminated with the base layer 12 partially over a second surface 124 of the base layer 12 opposite to the first patterned layer 14.

The film 10 may further include a protecting layer 18 laminated with the base layer 12 entirely over the entire first surface 122 and covering the first patterned layer 14, if the film 10 is needed to prevent the first patterned layer 14 from abrasion. The protecting layer 18 may be ink having good abrasion resistance. Moreover, the film 10 may further include a shading layer 19 laminated with the base layer 12 entirely over the entire second surface 124 and covering the second patterned layer 16, if the film 10 is needed to prevent light emitted via the first surface 122 from entering the second surface 124. The shading layer 19 can be made of an opaque, black color material (e.g., the mixture of resin and carbon).

The material for the base layer 12 may be a resin sheet of a single body or a copolymer of a polypropylene, polyamide, polycarbonate, polymethyl methacrylate et al. The base layer 12 may have a thickness of 0.5 millimeters (mm) to 1 mm.

The first patterned layer 14 has a plurality of first patterns. In this embodiment, the first patterned layer 14 is belt-shaped including a plurality of spaced first strip patterns 142, the FIGURE only labels two first strip patterns 142 for illustration. Adjacent first strip patterns 142 defines a first interval space 144 in between. The second patterned layer 16 is belt shaped including a plurality of spaced second strip patterns 162 corresponding to the first strip patterns 142, the FIGURE only labels two adjacent second strip patterns 162 for illustration. Between each second strip pattern 162 and another nearest second strip pattern 162 has a second interval space 164.

The first patterned layer 16 has a plurality of second pattern. In this exemplary embodiment, the second strip patterns 162 partially overlap with first strip pattern 142 and the rest of the second strip patterns 162 are partially overlapped with corresponding first interval spaces 144, so that the first strip patterns 142 and the second strip patterns 162 be exposed simultaneously in the direction perpendicular to the film 10. The first interval spaces 144 are partially overlapped with corresponding second interval spaces 164 also, in other words, the first interval spaces 144 are partially aligned with the second interval spaces 164, correspondingly. Thus, light transmitted to the film 10 is partially reflected by the first strip patterns 142, and is partially passes through the base layer 12 toward the second strip patterns 162. Then, the light passing through the base layer 12 is reflected by the second strip patterns 162 and is reversely transmitted in the base layer 12. When the light reflected by the second strip patterns 162 travels to the first surface 122 of the base layer 12, the light reflected by the second strip patterns 162 is refracted because the first surface 122 acts as an interface between the base layer 12 and air or acts as an interface between the base layer 12 and the protecting layer 18. Therefore, light reflected by the first strip pattern 142 and light reflected by the second strip patterns 162 interacts at the first surface 122, and light reflected by the second strip patterns 162 is refracted at the first surface 122, thus producing a dynamic appearance of the film 10.

As a material for the first patterned layer 14 and the second patterned layer 16, it is proper to employ a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye of an appropriate color as a coloring as a coloring agent. As a method for forming the first patterned layer 14 and the second patterned layer 16, it is proper to use an ordinary printing method such as the gravure printing method, the screen printing method or the offset printing method.

In this embodiment, the substrate 20 is integrally molded on the shading layer 19 of the film 10. It is envisioned that the substrate 20 will be directly integrally molded with the base layer 12 over the second surface 124 and covering the second patterned layer 16, when the film 10 don't include the shading layer 19. The substrate 20 is made of a thermoplastic material chosen from the group consisting of polyethylene, polycarbonate, acrylonitrile bivinyl styrene, polymethyl methacrylate, and any combination thereof.

It is understood that the first strip patterns 142 of the first patterned layer 14 may be partially off-set with the second strip patterns 162 of the second patterned layer 16. That is to say, the second strip patterns 162 of the second patterned layer 16 is only overlapped with the first interval spaces 144 of the first patterned layer 14. At this case, the light transmitted to the film 10 also can be partially reflected by the first strip patterns 142, and is partially passes through the base layer 12 toward the second strip patterns 162.

It is to be understood, however, that even though numerous characteristics and advantages of the exemplary disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A film comprising:
a base layer, the base layer including a first surface and a second surface opposite to the first surface;
a first patterned layer, the first patterned layer laminated with the base layer partially over the first surface of the base layer, the first patterned layer being belt-shaped and including a plurality of spaced first strip patterns such that a first interval space is defined between adjacent two first strip pattern; and
a second patterned layer, the second patterned layer laminated with the base layer partially over the second surface of the base layer, the second patterned layer being belt-shaped and including a plurality of spaced second strip patterns corresponding to the first strip patterns;
wherein in the direction perpendicular to the film, the second strip patterns are partially overlapped with corresponding first strip patterns and the rest of the second strip patterns are partially overlapped with corresponding first interval spaces.

2. The film of claim 1, wherein the base layer is made of a resin sheet of a single body or a copolymer of a polypropylene, polyamide, polycarbonate, polymethyl methacrylate.

3. The film of claim 1, wherein the base layer has a thickness of approximately 0.5 to 1 mm.

4. The film of claim 1, wherein the first patterned layer and the second patterned layer both of which are made of a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye of an appropriate color as a coloring as a coloring agent.

5. The film of claim 1, wherein the film further includes a protecting layer laminated with the base layer entirely over the first surface and covering the first patterned layer.

6. The film of claim 5, wherein the protecting layer be made of an ink with good abrasion resistance.

7. The film of claim 1, wherein the film further includes a shading layer laminated with the base layer entirely over the second surface and covering the second patterned layer.

8. The film of claim 7, wherein the shading layer be made of an opaque, black color material.

9. The film of claim 7, wherein the shading layer be made of the mixture of resin and carbon.

10. A housing comprising:
a substrate; and
a film comprising:
a base layer, the base layer including a first surface and a second surface opposite to the first surface;
a first patterned layer, the first patterned layer laminated with the base layer partially over the first surface of the base layer, the first patterned layer being belt-shaped and including a plurality of spaced first strip patterns such that a first interval space is defined between first strip pattern adjacent two first strip pattern; and
a second patterned layer, the second patterned layer laminated with the base layer partially over the second surface of the base layer, the second patterned layer being belt-shaped and including a plurality of spaced second strip patterns corresponding to the first strip patterns;
wherein in the direction perpendicular to the film, the second strip patterns are partially overlapped with corresponding first strip patterns and the rest of the second strip patterns are partially overlapped with corresponding first interval spaces.

11. The housing of claim 10, wherein the base layer is made of a resin sheet of a single body or a copolymer of a polypropylene, polyamide, polycarbonate, polymethyl methacrylate.

12. The housing of claim 10, wherein the base layer has a thickness of approximately 0.5 to 1 mm.

13. The housing of claim 10, wherein the first patterned layer and the second patterned layer both of which are made of a resin such a polyvinyl based resin, a polyamide based resin, a polyester based resin, an acrylic resin, a polyurethane based resin, apolyvinyl acetal based resin, a cellulose ester based resin, or an alkyd resin as a binder and employ a coloring ink that contains a pigment or dye of an appropriate color as a coloring as a coloring agent.

14. The housing of claim 10, wherein the film further includes a protecting layer laminated with the base layer entirely over the first surface and covering the first patterned layer.

15. The housing of claim 14, wherein the protecting layer be made of an ink with good abrasion resistance.

16. A film comprising:
a base layer, the base layer including a first surface and a second surface opposite to the first surface;
a first patterned layer, the first patterned layer formed on the first surface of the base layer and having a plurality of first pattern; and
a second patterned layer, the second patterned layer formed the base layer and having forming a plurality of second pattern;
wherein the first pattern of the first patterned layer are partially off-set with corresponding second pattern of the second patterned layer.

17. The housing of claim 14, wherein the first pattern and the second pattern both are strip.

18. The film of claim 16, wherein the base layer has a thickness of approximately 0.5 to 1 mm.

19. The film of claim 16, wherein the film further includes a protecting layer laminated with the base layer entirely over the first surface and covering the first patterned layer.

20. The housing of claim 19, wherein the protecting layer be made of an ink with good abrasion resistance.
